(19) United States
(12) Patent Application Publication
(10) Pub. No.: US 2007/0035731 A1
(43) Pub. Date: Feb. 15, 2007

(54) Direct alignment in mask aligners

(76) Inventors: Thomas Hülsmann, Garching (DE); Wolfgang Haenel, Eching (DE); Philippe Stievenard, Valenciennes (FR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/573,620

(22) PCT Filed: Nov. 24, 2004
(86) PCT No.: PCT/EP04/13380

§ 371 Date: Mar. 28, 2006

(30) Foreign Application Priority Data
Nov. 28, 2003 (DE) 103 55 681.8

(51) Int. Cl. G01B 11/00

(52) U.S. Cl. 356/401

(57) ABSTRACT

The invention relates to a method for aligning two flat substrates with one another, wherein each substrate has at least one aligning mark for mutual alignment, particularly for aligning a mask with a wafer before exposure. After aligning the two substrates in a first aligning step by optically determining the position of the alignment mark of the first substrate, storing the position of the first substrate, and moving the second substrate parallel to the first substrate so that the alignment mark of the second substrate corresponds with the stored position of the alignment mark of the first substrate, in a second aligning step the alignment is verified and a fine adjustment is carried out if necessary. In this second step the alignment marks of both substrates are observed essentially simultaneously, and both substrates are aligned with one another by a relative movement parallel to the substrate plane.

The invention relates to a method for adjusting or aligning two flat substrates, e.g., a mask with a wafer or two wafers with each other.

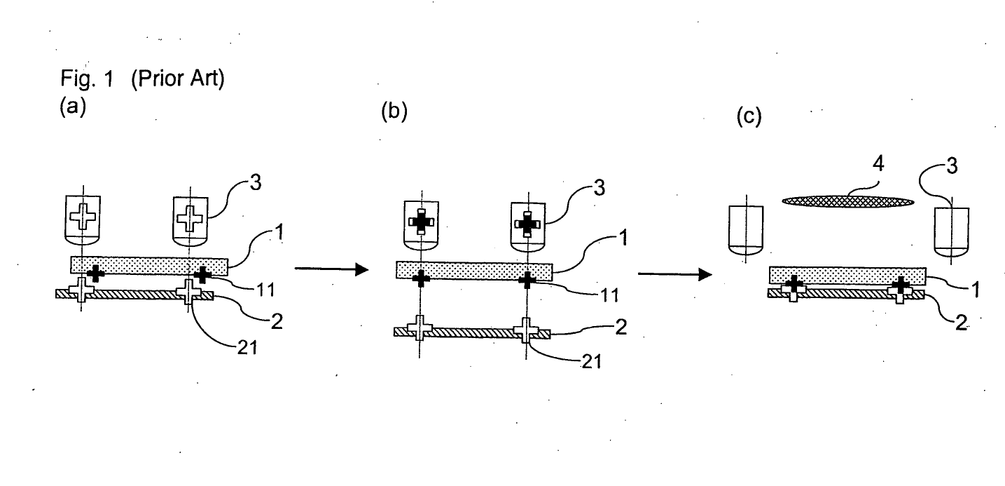

In the production of semiconductor components, the mask and the wafer have to be first adjusted or aligned with each other before exposure of a substrate or a wafer through a mask. This is normally done in a mask aligner or a mask positioning means. Both the mask and the wafer have alignment marks by means of which the mask can be positioned relative to the wafer. In a known alignment method, which is schematically shown in FIG. 1, the respective alignment marks 11 and 21 on the mask 1 and the wafer 2 are observed or monitored through microscopes 3. In this known method, the mask 1 is first moved parallel with respect to the surface of the wafer 2 so that the alignment marks 21, which are alignment crosses in the Figure, can be observed through the microscopes 3 (FIG. 1a). To this end, the mask is either moved only to such an extent into the “clearfield” that the alignment marks 21 of the wafer 2 are visible through the microscopes 3, or the mask is moved completely out of the object field of the microscope 3. The latter case is also referred to as “large clearfield” alignment. While the mask 1 is located in the clearfield or large clearfield, the microscopes are centered relative to the alignment marks 21 on the wafer 2, and the position or the image of the alignment marks 21 is stored.

In a next step, the wafer 2 is moved, if necessary, in the direction of the optical axis of the microscope 3, i.e. perpendicularly with respect to the plane of the wafer 2, and the mask 1 is brought into a position in which the alignment marks 11 on the mask 1 can be observed through the microscopes 3 (FIG. 1b). The positions of the alignment marks 11 of the mask 1 are made to correspond with the stored positions of the alignment marks 21 of the wafer 2, and the mask 1 is thus positioned. Said alignment method is therefore also referred to as indirect alignment.

The wafer is then moved back into the exposure distance or exposure gap, the microscopes 3 are removed from the region above the mask 1, and the wafer is exposed by means of an exposure means 4 through the mask 1 (FIG. 1c). The exposure gap might be zero, i.e. exposure takes place when the wafer is in contact with the mask.

The example in FIG. 1 shows the so-called top side alignment (TSA) method in which the alignment microscopes 3 and the exposure means 4 are on the same side above the mask 1. In the so-called bottom side alignment (BSA) method, the alignment microscopes are on opposing or facing sides of the wafers to be positioned so that the alignment marks 11 of the mask 1 have to be stored prior to the insertion of the wafer, and then the wafer 2 is aligned with the stored image. This method is also used in infrared alignment in lithography in which the alignment marks on the mask can be observed through a silicon substrate because of the use of infrared light. The problem of exactly aligning two flat substrates with each other becomes also apparent when bonding two substrates. In this case, too, the alignment method described above is used, e.g., when bonding a glass wafer and a silicon wafer or when bonding two silicon wafers by means of infrared alignment. The basic idea of the alignment method described above is disclosed in EP-B-0 556 669.

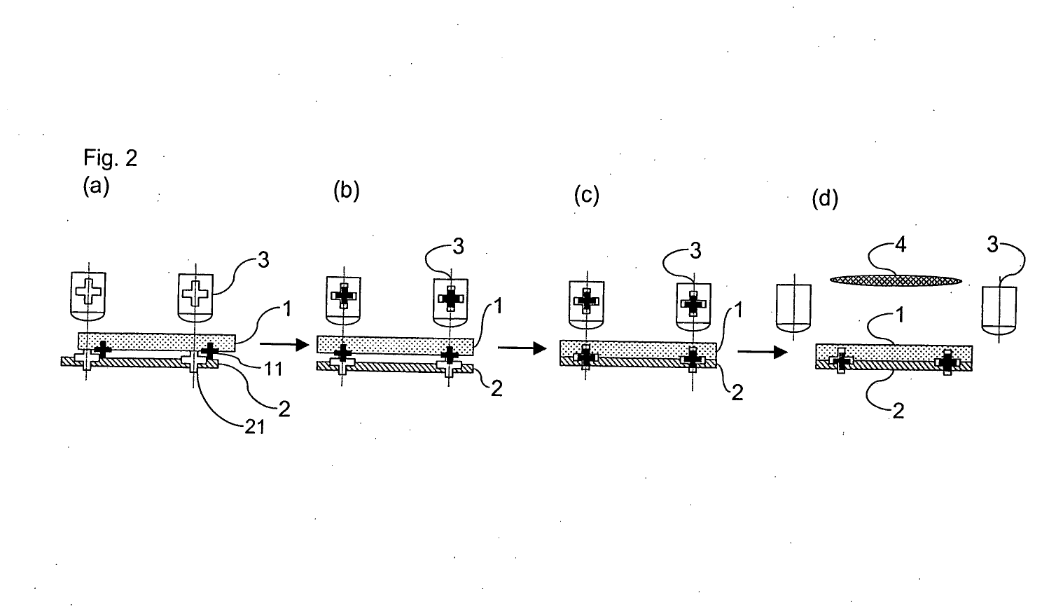

This method is disadvantageous in that the position(s) of the substrate and/or the wafer change(s) due to the movement in the direction of the optical axis of the microscope for observing the alignment marks of the mask so that the alignment might become inaccurate. In addition, due to the movement of the mask into the clearfield, the substrate and/or the alignment microscopes might move. Moreover, the microscope has to be refocused between the observation of the alignment marks of the substrate and the observation of the alignment marks of the mask because the mask and the substrate are not at the same distance from the microscope. Also this refocusing of the microscope might lead to inaccuracies. In order to avoid a refocusing of the microscope, alternatively also the distance between microscope and mask might be changed during the alignment process, wherein also these movements might negatively affect the alignment accuracy. In an improved method, the position of the mask relative to the wafer is measured or checked before exposure in order to increase the alignment accuracy (FIG. 2). This step is schematically shown in FIG. 2c. After having positioned the mask 1, the wafer 2 is moved so that there is an exposure gap or it is brought in contact with the mask 1. If the exposure gap is sufficiently small, both the wafer and the mask can thus be brought into focus simultaneously, and it is possible to determine whether the two alignment marks correspond with each other. If an alignment error that is greater than a predetermined minimum accuracy is observed in said step, the method as described above with reference to FIG. 1 is repeated.

However, it is disadvantageous that the latter method is very time consuming since in case of an inaccurate alignment the entire alignment process is repeated. Moreover, moving the mask in and out might lead to contamination of the mask and wafer. Because of the contact, there is also the risk that the mask and/or wafer is/are damaged.

U.S. Pat. No. 4,595,295 describes an alignment system for lithographic proximity printing. U.S. Pat. No. 4,794,648 describes a mask aligner comprising a device for detecting the wafer position.

It is therefore an object of the present invention to provide an improved method for mutually aligning two flat substrates, e.g., a mask with a wafer or two wafers with each other. In particular, the method of the present invention is to solve the above-mentioned problems and improve the adjustment or alignment accuracy.

This object is achieved with the features of the claims.

The present invention starts out from the basic idea to verify and/or correct the mutual positions of the two substrates in an additional step while the substrates are preferably perpendicular with respect to the surfaces of the substrates at a distance from each other. After indirect alignment in accordance with the above known method, the alignment marks of the two substrates that have to be aligned with each other are essentially simultaneously observed optically, e.g., by means of an alignment microscope. The two substrates can be, e.g., two wafers or a mask and a wafer.

During the observation, the distance or gap between the two substrates preferably corresponds to the distance at which the subsequent exposure of the wafer through the mask is carried out. The two substrates can also contact each other during the observation (contact exposure). In said latter case, however, the optionally necessary correction of the positions of the substrates must be carried out with the substrates being spaced from each other. In the following, said alignment is referred to as direct alignment.

For the direct alignment the two alignment marks must be simultaneously visible and distinguishable. Currently used image recognition methods, e.g., methods with edge recognition, are suitable therefor. To be able to observe both alignment marks simultaneously, the alignment microscope is preferably adjusted such that the focal plane is approximately in the middle between the two substrates. The images of the two alignment marks are therefore slightly fuzzy or out of focus. With the common exposure distances of about 20 to 50 μm in combination with modern image processing programs which are able to process even slightly fuzzy images with high accuracy, however, this does not limit the alignment accuracy.

It is an advantage of the method of the present invention that the adjustment or alignment of the mask relative to the substrate is verified and carried out in the arrangement in which the substrate is also exposed. Thus, in contrast to the conventional methods, no movement of the substrates to be aligned, which might distort the alignment, is necessary after the alignment. Moreover, in contrast to the above-mentioned verification of the alignment in contact, it is possible in accordance with the present method to correct the position of the mask and/or substrate during the direct alignment. It is therefore not necessary to carry out a time-consuming repetition of the alignment process in case an alignment error is detected.

Furthermore, the direct alignment method according to the present invention can also be combined with the measurement in contact so that the method is not only suitable for exposures with a small exposure gap, so-called proximity exposures, but can also be used for exposures in contact or for the arrangement of two substrates during bonding.

In the following the invention will be described in more detail with reference to the enclosed drawings in which

FIG. 1 schematically shows the steps of the conventional method for aligning a mask with a substrate;

FIG. 2 shows the method steps of an improved method for aligning a mask with a substrate, said method comprising the additional step of measuring in contact or with an exposure gap,

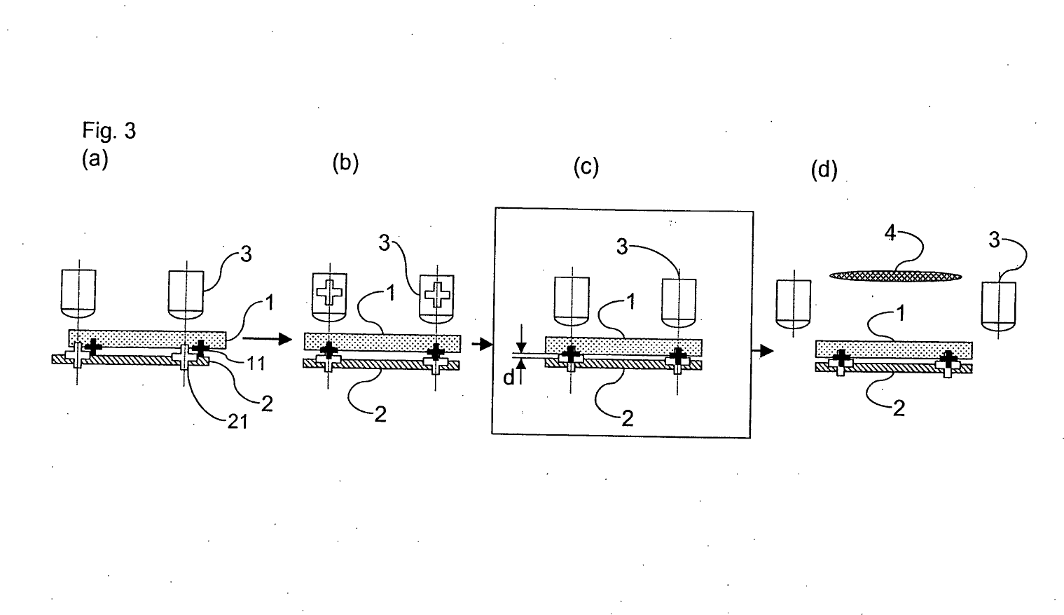

FIG. 3 shows the steps of a method for aligning a mask with a substrate, thereby using direct alignment according to the present invention,

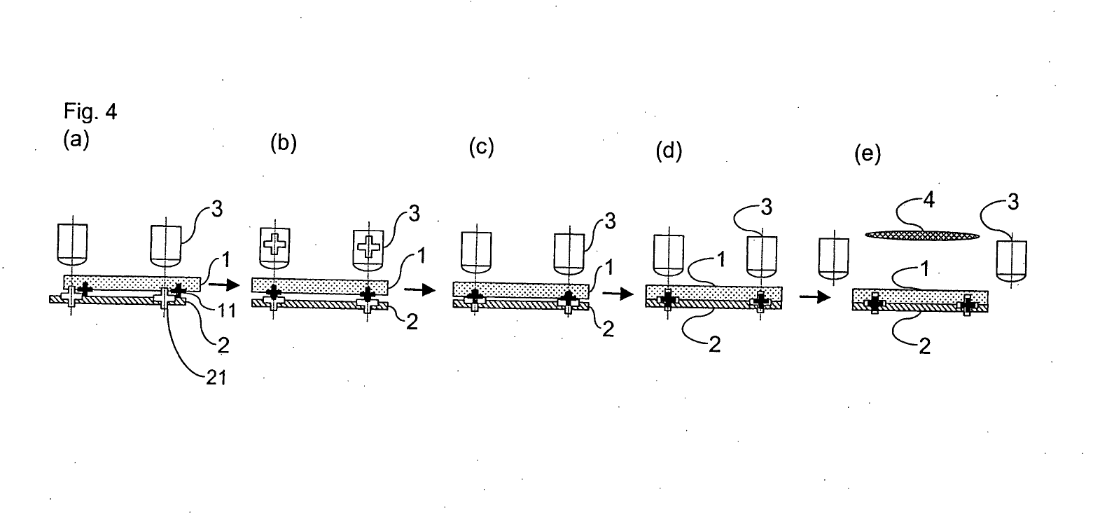

FIG. 4 shows the steps of a method for aligning a mask with a substrate, wherein direct alignment according to the present invention is combined with measurement in contact, and

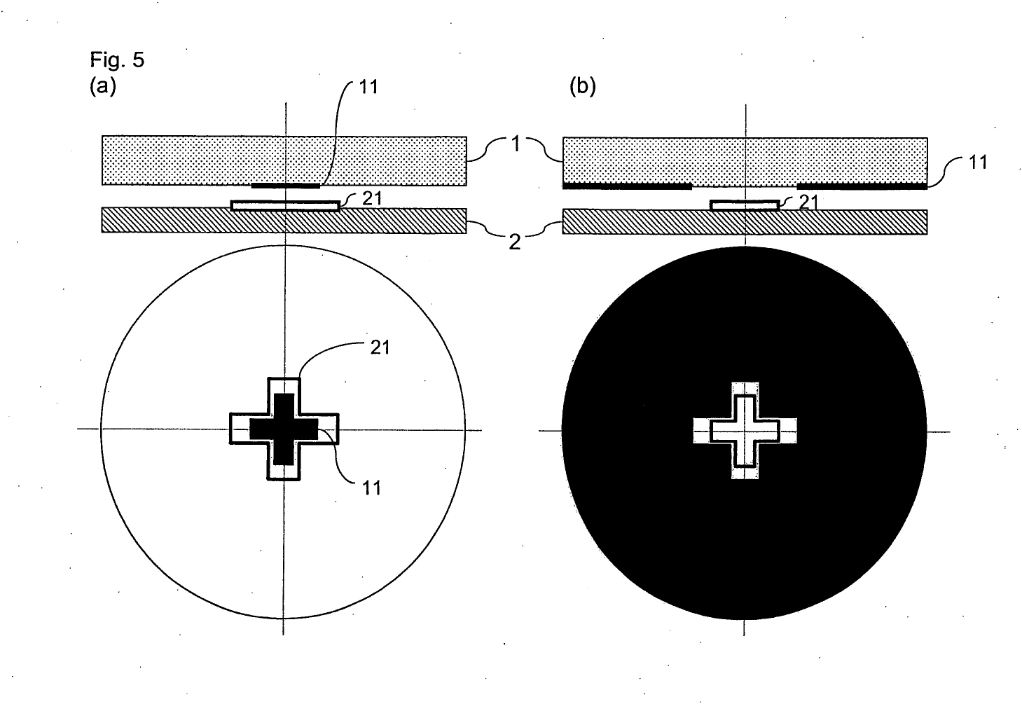

FIG. 5 schematically shows the alignment marks in case of a dark field mask (FIG. 5a) and a bright field mask (FIG. 5b).

FIG. 3 schematically shows the method steps of the method according to the present invention for aligning two flat substrates exemplarily for the alignment of a mask 1 with a substrate or wafer 2. The first two steps, i.e. centering the microscope and storing the positions of the alignment marks 21 of the wafer 2 (FIG. 3a) as well as aligning the mask by means of the positions of the alignment marks of the mask 1 and the stored positions of the alignment marks 21 of the wafer 2 (FIG. 3b), correspond to the steps of the conventional method which is described above with reference to FIG. 1.

After alignment of the mask 1, the wafer 2 is moved so as to form the exposure gap d, and the positions of the alignment marks 11 and 21 of the mask 1 and the wafer 2, respectively, are optically determined by the microscope 3 in accordance with the present invention. Possible alignment errors can be corrected directly in this step. Like in the conventional method, the microscopes are then removed and the wafer is exposed through the mask. According to the present invention, exposure takes place without changing the arrangement of the mask 1 and the wafer 2 after the final alignment. The only movement which takes place in the system between alignment and exposure and which could thus affect the alignment accuracy is thus the removal of the microscopes. The alignment accuracy is therefore clearly increased.

The method of the present invention cannot only be carried out in the above-mentioned top side alignment arrangement but also in the bottom side alignment arrangement. In this latter arrangement it is additionally not necessary to remove the microscopes, which again increases the alignment accuracy.

If it is intended to expose the wafer through the mask not at a certain distance between mask and wafer but in contact, the direct alignment of the present invention can also be combined with the measurement in contact as described above with reference to FIG. 2. To this end, the direct alignment of the mask 1 with the wafer 2 (FIG. 4c), in which the mask 1 and the wafer 2 are at a certain distance from each other so that the position of the mask 1 can be corrected during direct alignment, is followed by an additional step in which the wafer 2 is brought in contact with the mask 1. In this arrangement, the position of the mask 1 relative to the wafer 2 can be verified again directly and, in case alignment errors are determined, direct alignment can be repeated.

The above combination of direct alignment with measurement in contact can also be used for aligning two wafers with each other. For example, if a glass wafer and a silicon wafer are to be bonded, the alignment mark of the silicon wafer can be observed optically in the visible region through the glass wafer. If two silicon wafers are to be aligned with each other, so-called infrared alignment is used in which the alignment marks of the one wafer are observed through the other wafer by means of infrared light.

For direct alignment, the alignment marks of both the mask and the wafer must be visible simultaneously. FIG. 5a shows the alignment mark for a bright field mask or positive mask. The alignment mark 21 of the wafer 2, which is an alignment cross in the depicted example, is slightly larger than the mark 11 of the mask 1 lying on top thereof. The difference in size should preferably be at least 4 μm. If, in contrast to the shown example, no positive mask but a negative mask is used, i.e. a mask in which the mark is an opening in an otherwise covered surface, as shown in FIG. 5b, the mark of the mask has to be larger than that of the wafer. However, also in this case the difference in size should preferably be at least 4 μm.

By the additional method step, i.e. direct alignment, in accordance with the present invention, the time necessary for adjusting or aligning the mask with the wafer is slightly increased relative to the conventional method. This means that the time necessary for aligning and exposing the waver is about 1 minute. Since two wafers are treated at the same time in modern mask aligners, the throughput is two wafers per minute. As compared to conventional methods in which the alignment is verified by measurement in contact, the method of the present invention provides an advantage as regards the speed because it is not necessary to repeat the entire alignment process in case an alignment error has been determined.

As compared to conventional methods, a clearly higher alignment accuracy can be achieved with the method of the present invention. While it is possible to achieve accuracies of several μm in conventional alignment methods, accuracies of less than 0.5 μm have been achieved with the method of the present invention.

1. A method for aligning two flat substrates (1, 2) being arranged an essentially parallel distance between each other and each having at least one alignment mark (11, 21, respectively) for mutual alignment, the method comprising the following method steps:
(1) a first alignment step including
(1.1) optically determining the position of the alignment mark (21) of the first substrate (2),
(1.2) storing the position of the alignment mark (21) of the first substrate (2) and
(1.3) moving the second substrate (1) parallel with respect to the first substrate (20 so that the position of the alignment mark (11) of the second substrate (1) corresponds with the stored position of the alignment mark (21) of the first substrate (2), and
(2) a second alignment step including
(2.1) essentially simultaneously observing the position of the two alignment marks (11, 21) of the two substrates (1, 2) and
(2.2) aligning the alignment marks (11, 21) of the two substrates (1, 2) with each other by means of a relative movement of the two substrates (1, 2) in planes of the two substrates.

2. The method according to claim 1, wherein both the substrates are wafers.

3. The method according to claim 1, wherein one substrate (1) is a mask and the other substrate (2) is a wafer.

4. The method according to claim 1, wherein in method step (2.1) the parallel distance between the two substrates is about 0 μm to about 100 μm.

5. The method according to claim 1, wherein in method step (2.2) the parallel distance between the two substrates is larger than or equal to the parallel distance between the substrates in method step (2.1).

6. The method according to claim 1, wherein the alignment marks (11, 21) are observed by means of an alignment microscope (3).

7. The method according to claim 6, wherein a focal plane of the alignment microscope (3) lies between the two substrates (1, 2).

8. The method according to claim 1, wherein the positions of the alignment marks (11, 21) are determined by an automatic image recognition.

9. The method according to claim 3, wherein in method step (2) the parallel distance between the two substrates corresponds to the a distance at which subsequent exposure of the wafer through the mask is carried out.
